(19) United States
(12) Patent Application Publication
(10) Pub. No.: US 2022/0352673 A1
(43) Pub. Date: Nov. 3, 2022

(54) PROTECTIVE SLEEVE AND CABLE CONNECTOR ASSEMBLY HAVING THE SAME

(71) Applicant: DONGGUAN LUXSHARE TECHNOLOGIES CO., LTD, Dongguan City (CN)

(72) Inventors: Sihai YI, Dongguan City (CN); Zhaolong ZENG, Dongguan City (CN); Yanrong CHEN, Dongguan City (CN); Kaide WANG, Dongguan City (CN); Yisen XIONG, Dongguan City (CN); Qiongnan CHEN, Dongguan City (CN)

(73) Assignee: DONGGUAN LUXSHARE TECHNOLOGIES CO., LTD, Dongguan City (CN)

(21) Appl. No.: 17/527,425

(22) Filed: Nov. 16, 2021

(30) Foreign Application Priority Data
Apr. 30, 2021 (CN) 202120943289.6

(51) Int. Cl. H01R 13/58

(52) U.S. Cl. CPC H01R 13/5804

(57) ABSTRACT

The present disclosure discloses a protective sleeve used for matching with a cable of a cable connector. The protective cover is used to be fixed on the cable to prevent the cable from being excessively bent. The present disclosure also discloses a cable connector assembly having the protective sleeve. Compared with the prior art, the present disclosure is capable of preventing the cable from being excessively bent by providing the protective cover fixed on the cable.

### CROSS-REFERENCE TO RELATED APPLICATION

This patent application claims priority of a Chinese Patent Application No. 202120943289.6, filed on Apr. 30, 2021 and titled “PROTECTIVE SLEEVE AND CABLE CONNECTOR ASSEMBLY”, the entire content of which is incorporated herein by reference.

### TECHNICAL FIELD

The present disclosure relates to a protective sleeve and a cable connector assembly, which belongs to a technical field of connectors.

### BACKGROUND

According to different wiring requirements, bending a cable of a cable connector is a conventional design in the technical field. As electronic products have higher and higher requirements for signal transmission, excessive bending of the cable will affect the quality of signal transmission, and even interrupt signal transmission.

### SUMMARY

An object of the present disclosure is to provide a protective sleeve and a cable connector assembly which is capable of preventing the cable from being excessively bent.

In order to achieve the above object, the present disclosure adopts the following technical solution: a protective sleeve, the protective sleeve being adapted to mate with a cable of a cable connector, the protective sleeve being adapted to be fixed on the cable to prevent the cable from being excessively bent.

In order to achieve the above object, the present disclosure adopts the following technical solution: a cable connector assembly, including: a cable connector; and a protective sleeve; the cable connector including: a connector plug; and a cable electrically connected to the connector plug; wherein the protective sleeve is fixed on the cable, and the protective sleeve and the cable covered by the protective sleeve are bent together during bending so as to prevent the cable from being excessively bent.

In order to achieve the above object, the present disclosure adopts the following technical solution: a cable connector assembly, including: a cable connector; and a protective sleeve; the cable connector including: a connector plug; and a cable electrically connected to the connector plug; wherein the protective sleeve is fixed on the cable to prevent the cable from being excessively bent, the protective sleeve includes a sleeve portion and a clamping portion connected to the sleeve portion, the clamping portion extends a length along an extending direction of the cable; and wherein the sleeve portion is in a ring shape with a closed outer periphery so as to be sleeved on a part of the cable, and the clamping portion is an open structure with a non-closed outer periphery so as to be clamped on a part of the cable.

Compared with the prior art, the present disclosure is capable of preventing the cable from being excessively bent by providing the protective sleeve fixed on the cable. In addition, the sleeve portion with the closed outer periphery can be reliably sleeved on a part of the cable so as to prevent the protective sleeve from falling off the cable. The non-closed outer periphery of the clamping portion can reduce the difficulty of assembling with the cable.

### BRIEF DESCRIPTION OF DRAWINGS

FIG. 1 is a perspective schematic view of a cable connector assembly in accordance with a first embodiment of the present disclosure;

FIG. 2 is a perspective schematic view of FIG. 1 from another angle;

FIG. 3 is a top view of FIG. 1;

FIG. 4 is a bottom view of FIG. 1;

FIG. 5 is a front view of FIG. 1;

FIG. 6 is a left side view of FIG. 1;

FIG. 7 is a right side view of FIG. 1;

FIG. 8 is a partially exploded perspective view of FIG. 1, in which a protective sleeve is separated;

FIG. 9 is a further perspective exploded view of FIG. 8;

FIG. 10 is a perspective exploded view of FIG. 9 from another angle;

FIG. 11 is a schematic cross-sectional view taken along line A-A in FIG. 8;

FIG. 12 is a schematic cross-sectional view taken along line B-B in FIG. 8;

FIG. 13 is a perspective schematic view of the cable connector assembly in accordance with a second embodiment of the present disclosure;

FIG. 14 is a perspective schematic view of FIG. 13 from another angle;

FIG. 15 is a top view of FIG. 13;

FIG. 16 is a bottom view of FIG. 13;

FIG. 17 is a front view of FIG. 13;

FIG. 18 is a left side view of FIG. 13;

FIG. 19 is a right side view of FIG. 13;

FIG. 20 is a partially exploded perspective view of FIG. 13, in which the protective sleeve is separated;

FIG. 21 is a schematic cross-sectional view taken along line C-C in FIG. 20; and

FIG. 22 is a schematic cross-sectional view taken along line D-D in FIG. 20.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

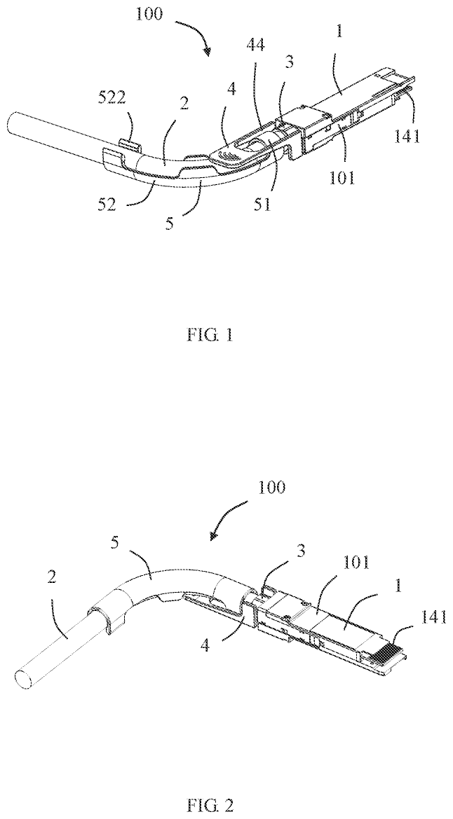

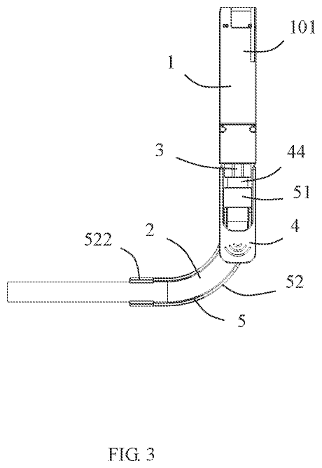

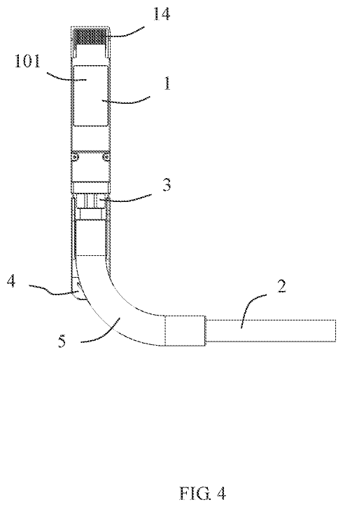

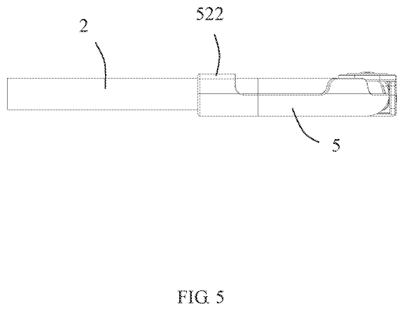

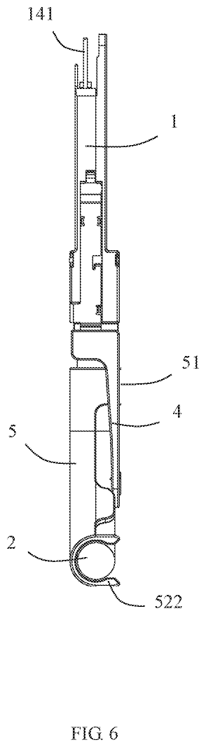

Referring to FIGS. 1 to 8, a first embodiment of the present disclosure discloses a cable connector assembly 100 including a cable connector 101 and a protective sleeve 5. The cable connector 101 includes a connector plug 1, a cable 2 electrically connected to the connector plug 1, a wire stop 3 located at a junction of the connector plug 1 and the cable 2, and a pull strap 4 connected to the connector plug 1. The protective sleeve 5 is fixed on the cable 2 so as to prevent the cable 2 from being excessively bent. In an illustrated embodiment of the present invention, the protective sleeve 5 and the cable 2 covered by the protective sleeve 5 are bent together during bending. In the first embodiment of the present disclosure, the cable 2 is a high-speed cable, and the cable connector 101 is used to transmit high-speed signals. In the illustrated embodiment of the present disclosure, the connector plug 1 is an SFP (Small Form-factor Pluggable) plug, that is, the cable connector 101 is a connector of a type related to an SFP cable connector. Of course, it is understandable to those skilled in the art that the cable connector 101 may also be other types of high-speed cable connectors, which will not be repeated in the present disclosure.

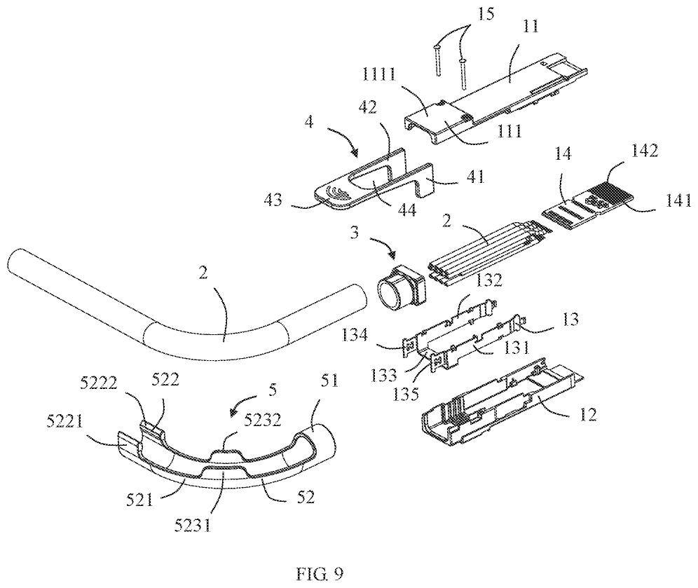

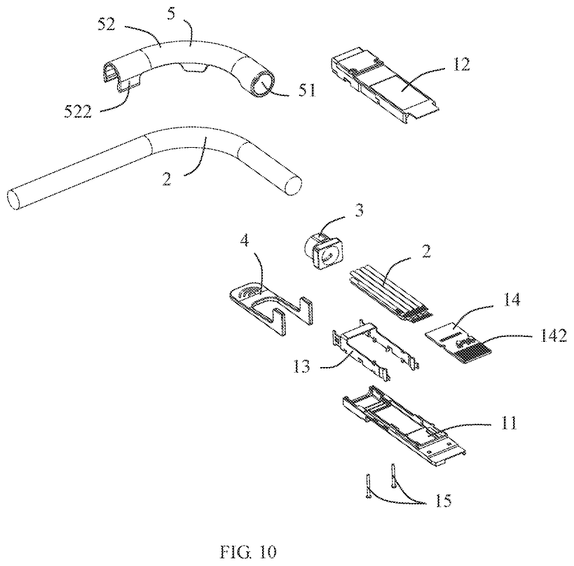

Referring to FIGS. 9 and 10, the connector plug 1 includes a first housing 11, a second housing 12, an unlocking mechanism 13, and a built-in circuit board 14 located between the first housing 11 and the second housing 12. The cable 2 and the built-in circuit board 14 are electrically connected by means such as soldering. The built-in circuit board 14 is provided with a mating tongue 141 and a plurality of conductive pads 142 exposed on the mating tongue 141. In an embodiment of the present disclosure, the conductive pads 142 are located on opposite surfaces of the mating tongue 141, respectively. The mating tongue 141 is used for being inserted into a slot of a mating connector (not shown). The conductive pads 142 are used to contact with conductive terminals of the mating connector.

In order to improve the shielding effect, both the first housing 11 and the second housing 12 are made of metal materials. The first housing 11 and the second housing 12 are fixed by bolts 15. The first housing 11 is provided with a raised first wall 111 (for example, a top wall) adjacent to the protective sleeve 5. The first wall 111 includes a first surface 1111 (for example, a top surface).

The unlocking mechanism 13 includes a first locking arm 131, a second locking arm 132 parallel to the first locking arm 131, a connecting wall 133 connecting the first locking arm 131 and the second locking arm 132, a first connecting portion 134 extending from one end of the connecting wall 133 in a direction away from the first locking arm 131, and a second connecting portion 135 extending from the other end of the connecting wall 133 in a direction away from the second locking arm 132. The first connecting portion 134 and the second connecting portion 135 are parallel to each other.

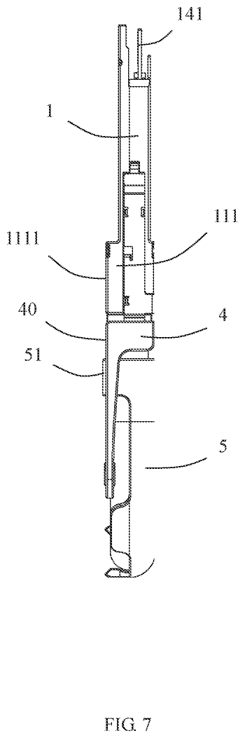

The pull strap 4 includes an outer surface 40 (for example, an upper surface) located on a same side as the first surface 1111. The outer surface 40 is substantially flush with the first surface 111 (referring to FIG. 7). It should be noted that the technical term “substantially flush” used in the present disclosure is intended to indicate that related surfaces are substantially flush, which includes the situation of not being completely flush due to manufacturing tolerances. The pull strap 4 includes a first side wall portion 41 and a second side wall portion 42 located on opposite sides and fixedly connected to the first connecting portion 134 and the second connecting portion 135 of the unlocking mechanism 13, respectively. In the illustrated embodiment of the present disclosure, the first side wall portion 41 and the second side wall portion 42 are both L-shaped. The pull strap 4 further includes a force applying portion 43 connecting an end of the first side wall portion 41 and an end of the second side wall portion 42, and a hollow portion 44 is located between the first side wall portion 41 and the second side wall portion 42. In an embodiment of the present disclosure, the pull strap 4 is a flexible pull strap so as to facilitate arrangement and operation.

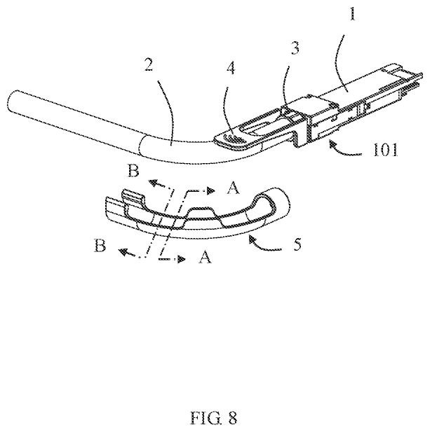

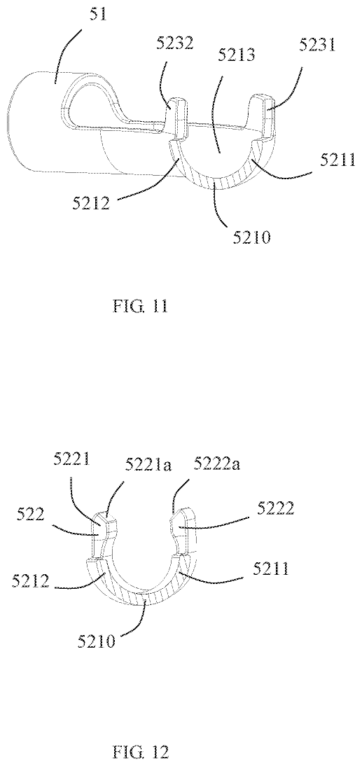

Referring to FIGS. 8 to 12, the protective sleeve 5 includes a sleeve portion 51 and a clamping portion 52 connected to the sleeve portion 51. The clamping portion 52 extends for a certain length along an extending direction of the cable 2. The sleeve portion 51 has a closed ring shape so as to be sleeved on a part of the cable 2 during assembling. The sleeve portion 51 is adjacent to the wire stop 3 so as to protect the cable 2 when the cable 2 just extends out of the connector plug 1. In the illustrated embodiment of the present disclosure, the sleeve portion 51 has an annular shape. The sleeve portion 51 is partially exposed in the hollow portion 44 of the pull strap 4 (referring to FIG. 1), and the sleeve portion 51 partially protrudes upwardly from the pull strap 4 (referring to FIG. 7). The clamping portion 52 has an open structure with a non-closed outer periphery so as to be easily clamped on a part of the cable 2.

In the illustrated embodiment of the present disclosure, the clamping portion 52 includes an extension portion 521 having an arc-shaped cross section. The extension portion 521 includes an arc-shaped wall portion 5210, and a first side wall 5211 and a second side wall 5212 extending from opposite sides of the wall portion 5210, respectively. The wall portion 5210, the first side wall 5211 and the second side wall 5212 form a receiving space 5213 to clamp the cable 2.

The clamping portion 52 includes a claw portion 522 located at an end of the extension portion 521 away from the sleeve portion 51. The claw portion 522 includes a first claw 5221 protruding from the first side wall 5211 in a direction perpendicular to the extending direction, and a second claw 5222 protruding from the second side wall 5212 in a direction perpendicular to the extending direction. The first claw 5221 includes a first guiding inclined surface 5221a for guiding the cable 2. The second claw 5222 includes a second guiding inclined surface 5222a for guiding the cable 2. The first claw 5221 and the second claw 5222 clamp the cable 2 in order to improve the installation reliability of the clamping portion 52 and the cable 2, and prevent the clamping portion 52 from falling off the cable 2.

In the illustrated embodiment of the present disclosure, the clamping portion 52 includes a third claw 5231 protruding from the first side wall 5221 in a direction perpendicular to the extending direction, and a fourth claw 5232 protruding from the second side wall 5222 in a direction perpendicular to the extending direction. The third claw 5231 is located between the sleeve portion 51 and the first claw 5221. The fourth claw 5232 is located between the sleeve portion 51 and the second claw 5222. The third claw 5231 and the fourth claw 5232 clamp the cable 2 in order to further improve the installation reliability of the clamping portion 52 and the cable 2, and prevent the clamping portion 52 from falling off the cable 2. In the illustrated embodiment of the present disclosure, a length of the third claw 5231 along the extending direction is greater than a length of the fourth claw 5232 along the extending direction, so as to protect the cable 2, and at the same time be convenient to bend the cable 2.

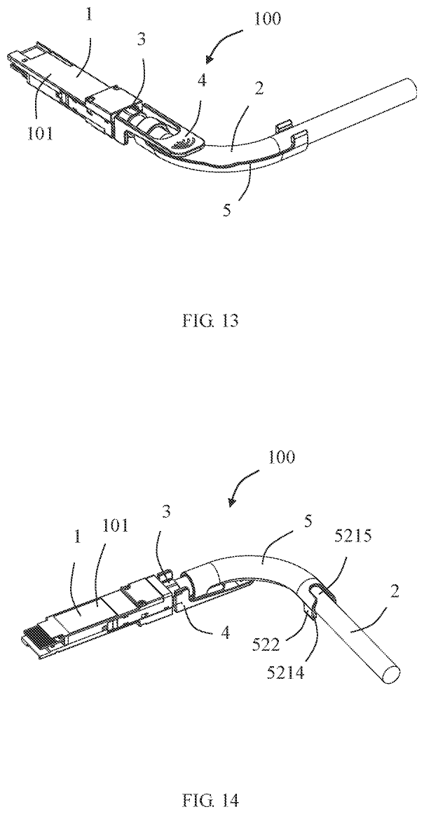

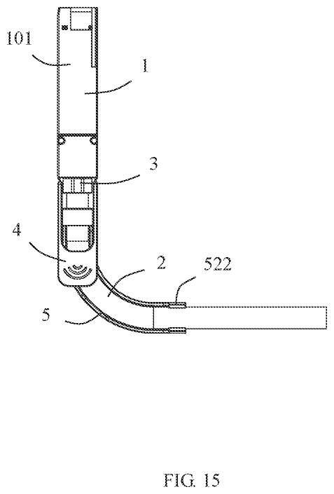

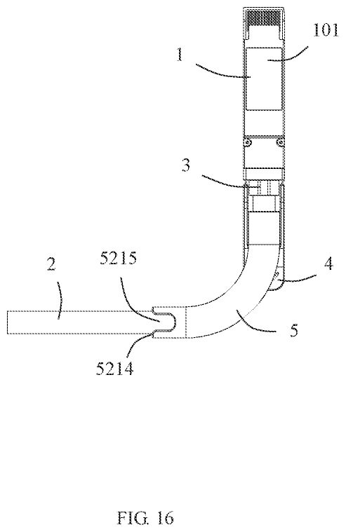

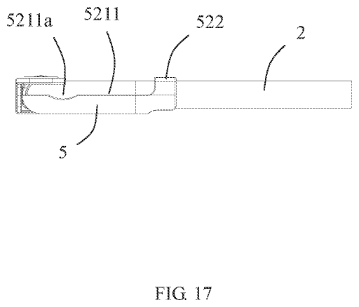

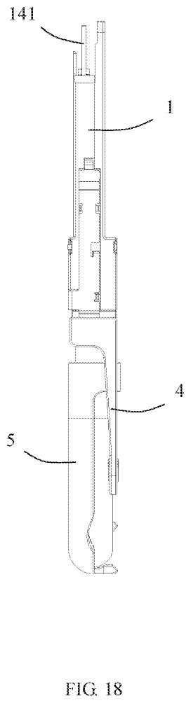

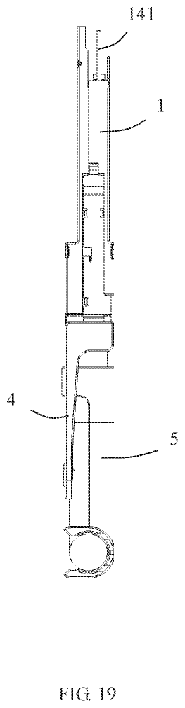

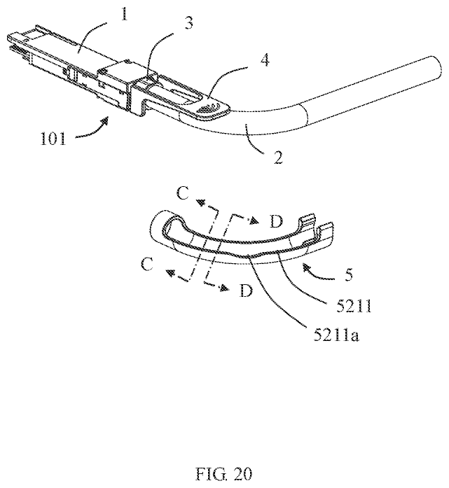

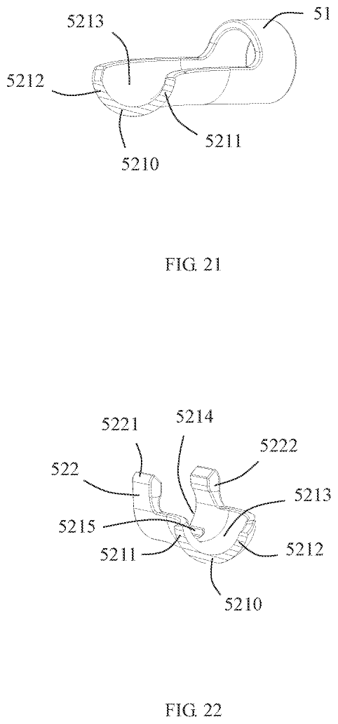

Referring to FIGS. 13 to 22, a second embodiment of the present disclosure discloses a similar cable connector assembly 100. The main difference between the first embodiment and the second embodiment is that the cable connector assembly 100 in the second embodiment is not provided with the third claw 5231 and the fourth claw 5232. At the same time, the cable connector assembly 100 in the second embodiment has a groove 5211a formed on the first side wall 5211 to facilitate assembly or disassembly of the protective sleeve 5. In addition, the extension portion 521 of the cable connector assembly 100 in the second embodiment includes an end surface 5214 away from the sleeve portion 51. The wall portion 5210 defines a slot 5215 extending through the end surface 5214 along the extending direction. By providing the slot 5215, the elasticity of the end of the protective sleeve 5 away from the sleeve portion 51 is improved, thereby facilitating the clamping of the clamping portion 52 on the cable 2 or separating the clamping portion 52 from the cable 2.

In the illustrated embodiment of the present disclosure, the protective sleeve 5 and the cable 2 are made separately, and then the protective sleeve 5 is assembled and buckled on the cable 2, and finally, it is relatively fixed with the cable 2. Of course, it is understandable to those skilled in the art that the relative position of the protective sleeve 5 and the cable 2 can be changed. For example, before the clamping portion 52 is fixed to the cable 2, the sleeve portion 51 can slide freely on the cable 2 in order to adjust the position of the protective sleeve 5 with respect to the cable 2. In other embodiments of the present disclosure, the protective sleeve 5 may also be formed on the cable 2 to be integrated with the cable 2 as a whole.

Compared with the prior art, the present disclosure is capable of preventing the cable 2 from being excessively bent by providing the protective sleeve 5 fixed on the cable 2. In addition, the sleeve portion 51 with the closed outer periphery can be reliably sleeved on the part of the cable 2 so as to prevent the protective sleeve 5 from falling off the cable 2. The clamping portion 52 with the non-closed outer periphery can reduce the difficulty of assembling with the cable 2.

The above embodiments are only used to illustrate the present disclosure and not to limit the technical solutions described in the present disclosure. The understanding of this specification should be based on those skilled in the art. Although descriptions of directions have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A protective sleeve, the protective sleeve being adapted to mate with a cable of a cable connector, the protective sleeve being adapted to be fixed on the cable to prevent the cable from being excessively bent.

2. The protective sleeve according to claim 1, further comprising a clamping portion, the clamping portion extending a length along an extending direction of the cable, the clamping portion being an open structure with a non-closed outer periphery so as to be clamped on a part of the cable.

3. The protective sleeve according to claim 2, further comprising a sleeve portion connected to the clamping portion, the sleeve portion being in a ring shape with a closed outer periphery so as to be sleeved on a part of the cable.

4. The protective sleeve according to claim 3, wherein the clamping portion comprises an extension portion with an arc-shaped cross section; the extension portion comprises an arc-shaped wall portion, and a first side wall and a second side wall extending from opposite sides of the wall portion, respectively; the wall portion, the first side wall and the second side wall jointly form a receiving space to clamp the cable.

5. The protective sleeve according to claim 4, wherein the clamping portion comprises a claw portion located at an end of the extension portion away from the sleeve portion, the claw portion comprises a first claw protruding from the first side wall in a direction perpendicular to the extending direction and a second claw protruding from the second side wall in a direction perpendicular to the extending direction; and wherein the first claw comprises a first guiding inclined surface to guide the cable, the second claw comprises a second guiding inclined surface to guide the cable, and the first claw and the second claw clamp the cable.

6. The protective sleeve according to claim 5, wherein the extension portion comprises an end surface away from the sleeve portion, and the wall portion defines a slot extending through the end surface along the extending direction.

7. The protective sleeve according to claim 5, wherein the clamping portion comprises a third claw protruding from the first side wall in a direction perpendicular to the extending direction and a fourth claw protruding from the second side wall in a direction perpendicular to the extending direction, the third claw is located between the sleeve portion and the first claw, the fourth claw is located between the sleeve portion and the second claw, and the third claw and the fourth claw clamp the cable.

8. The protective sleeve according to claim 7, wherein a length of the third claw along the extending direction is greater than a length of the fourth claw along the extending direction.

9. The protective sleeve according to claim 1, wherein the protective sleeve and the cable covered by the protective sleeve are bent together during bending.

10. A cable connector assembly, comprising:
a cable connector; and
a protective sleeve;
the cable connector comprising:
a connector plug; and
a cable electrically connected to the connector plug;
wherein the protective sleeve is fixed on the cable, and the protective sleeve and the cable covered by the protective sleeve are bent together during bending so as to prevent the cable from being excessively bent.

11. The cable connector assembly according to claim 10, wherein the protective sleeve comprises a clamping portion and a sleeve portion connected to the clamping portion, the clamping portion extends a length along an extending direction of the cable, the clamping portion is an open structure with a non-closed outer periphery so as to be clamped on a part of the cable, and the sleeve portion is in a ring shape with a closed outer periphery so as to be sleeved on a part of the cable.

12. The cable connector assembly according to claim 11, wherein the clamping portion comprises an extension portion with an arc-shaped cross section, the extension portion comprises an arc-shaped wall portion, and a first side wall and a second side wall extending from opposite sides of the wall portion, respectively, the wall portion, the first side wall and the second side wall jointly form a receiving space to clamp the cable.

13. The cable connector assembly according to claim 12, wherein the clamping portion comprises a claw portion located at an end of the extension portion away from the sleeve portion, the claw portion comprises a first claw protruding from the first side wall in a direction perpendicular to the extending direction and a second claw protruding from the second side wall in a direction perpendicular to the extending direction; and wherein the first claw comprises a first guiding inclined surface to guide the cable, the second claw comprises a second guiding inclined surface to guide the cable, and the first claw and the second claw clamp the cable.

14. The cable connector assembly according to claim 13, wherein the extension portion comprises an end surface away from the sleeve portion, and the wall portion defines a slot extending through the end surface along the extending direction;
wherein the clamping portion comprises a third claw protruding from the first side wall in a direction perpendicular to the extending direction and a fourth claw protruding from the second side wall in a direction perpendicular to the extending direction, the third claw is located between the sleeve portion and the first claw, the fourth claw is located between the sleeve portion and the second claw, and the third claw and the fourth claw clamp the cable; and
wherein a length of the third claw along the extending direction is greater than a length of the fourth claw along the extending direction.

15. A cable connector assembly, comprising:
a cable connector; and
a protective sleeve;
the cable connector comprising:
a connector plug; and
a cable electrically connected to the connector plug;
wherein the protective sleeve is fixed on the cable to prevent the cable from being excessively bent, the protective sleeve comprises a sleeve portion and a clamping portion connected to the sleeve portion, the clamping portion extends a length along an extending direction of the cable; and
wherein the sleeve portion is in a ring shape with a closed outer periphery so as to be sleeved on a part of the cable, and the clamping portion is an open structure with a non-closed outer periphery so as to be clamped on a part of the cable.

16. The cable connector assembly according to claim 15, further comprising a wire stop located at a junction of the connector plug and the cable, the sleeve portion being located adjacent to the wire stop.

17. The cable connector assembly according to claim 15, wherein the clamping portion comprises an extension portion with an arc-shaped cross section; the extension portion comprises an arc-shaped wall portion, and a first side wall and a second side wall extending from opposite sides of the wall portion, respectively; and the wall portion, the first side wall and the second side wall form a receiving space to clamp the cable; and
wherein the clamping portion comprises a claw portion located at an end of the extension portion away from the sleeve portion; the claw portion comprises a first claw protruding from the first side wall in a direction perpendicular to the extending direction and a second claw protruding from the second side wall in a direction perpendicular to the extending direction; the first claw comprises a first guiding inclined surface to guide the cable, the second claw comprises a second guiding inclined surface to guide the cable, and the first claw and the second claw clamp the cable.

18. The cable connector assembly according to claim 17, wherein the extension portion comprises an end surface away from the sleeve portion, and the wall portion defines a slot extending through the end surface along the extending direction;
wherein the clamping portion comprises a third claw protruding from the first side wall in a direction perpendicular to the extending direction and a fourth claw protruding from the second side wall in a direction perpendicular to the extending direction, the third claw is located between the sleeve portion and the first claw, the fourth claw is located between the sleeve portion and the second claw, and the third claw and the fourth claw clamp the cable; and
wherein a length of the third claw along the extending direction is greater than that of the fourth claw along the extending direction.

19. The cable connector assembly according to claim 15, wherein the protective sleeve is buckled on the cable or integrally formed on the cable.

20. The cable connector assembly according to claim 15, further comprising a flexible pull strap connected to the connector plug; wherein the pull strap comprises a hollow portion; and wherein the sleeve portion is partially exposed in the hollow portion and partially protrudes beyond the pull strap.
